(19) United States
(12) Patent Application Publication
(10) Pub. No.: US 2017/0173849 A1
(43) Pub. Date: Jun. 22, 2017

(54) METHODS FOR FORMING DIELECTRIC FILMS AND RELATED FILM CAPACITORS

(71) Applicant: General Electric Company, Schenectady, NY (US)

(72) Inventors: Norberto Silvi, Cliffton Park, NY (US); Kevin Warner Flanagan, Troy, NY (US); Daniel Qi Tan, Rexford, NY (US); Jeffrey S. Sullivan, Rexford, NY (US)

(21) Appl. No.: 14/975,942

(22) Filed: Dec. 21, 2015

(51) Int. Cl. B29C 55/14; B29C 55/04; B29C 55/00; B29C 55/16; H01G 4/33; H01G 4/06

(52) U.S. Cl. CPC B29C 55/146; H01G 4/33; H01G 4/06; B29C 55/005; B29C 55/16; B29C 55/04; B29K 2079/085

(57) ABSTRACT

A method for forming a bi-axially stretched dielectric film having a thickness less than 5 microns is presented. The method includes stretching a dielectric material along a transverse direction to form the bi-axially stretched dielectric film having a thickness less than 5 microns. The dielectric material is heated using infrared radiation during at least a duration of the stretching step. The dielectric material includes a substantially amorphous polymer having a glass transition temperature greater than 140 degrees Celsius.

### BACKGROUND

The disclosure relates generally to methods for forming dielectric films. More particularly, the disclosure relates to methods for forming bi-axially stretched dielectric films of amorphous polymers.

Over the last decade, significant improvements in capacitor reliability have been achieved through a combination of advanced manufacturing techniques and new materials. Enhanced performance has been obtained particularly in so-called film capacitors, such as metallized film capacitors.

Compared to other types of film capacitors, metallized film capacitors may provide certain advantages such as size, simplicity, and cost of manufacturing, and hence have been widely used in the power electronics industry. Typically, metallized film capacitors include two metal electrodes separated by a polymer film. An example of the commonly used polymer film includes polypropylene. However, polypropylene-based film capacitors may have challenges in high-temperature industrial applications because of polypropylene's inherent temperature limitations. Amorphous polymers, for example polyetherimide (PEI) resins have been recently considered as potential dielectric materials for the film capacitors because these polymers exhibit higher glass transition temperatures when compared to conventionally used polymers (such as, polypropylene). Polymer films formed using these amorphous polymers may have one or more of the desired characteristics for a film capacitor such as high temperature stability, desired heat resistance, desired voltage resistance, high dielectric breakdown voltage, high dielectric constant, and low dielectric loss.

Moreover, thinner polymer films (for example, with thickness less than 5 microns) are desirable to reduce both the cost and volume of the film capacitors made from such films. However, conventional methods for forming thin polymer films, for example, solvent-based methods may have several issues including the presence of residual solvent in the film, shrinkage, poor thermal stability, and dielectric properties. Melt-based methods may include blown film extrusion and stretching. Stretching may improve some physical properties of the polymer films, for example tensile strength and modulus of elasticity. However, forming thin films of amorphous polymers may be challenging because of the lack of appropriate methods and processing conditions to achieve the desired thickness (less than 5 microns), uniformity and quality.

Thus, there is a need for improved methods for forming thin dielectric films of amorphous polymers.

### BRIEF DESCRIPTION

Some aspects of the specification are directed to a method that includes stretching a dielectric material along a transverse direction to form a bi-axially stretched dielectric film having a thickness less than 5 microns. The dielectric material is heated using infrared radiation during at least a duration of the stretching step. The dielectric material includes a substantially amorphous polymer having a glass transition temperature greater than 140 degrees Celsius.

In some aspects of the specification, a bi-axially stretched dielectric film having a thickness less than 5 microns, formed by the method is provided. Some aspects present a film capacitor including the bi-axially stretched dielectric film.

In some aspects of the specification, a method includes providing a melt-extruded film including a polyetherimide; stretching the melt-extruded film along a longitudinal direction to form an uni-axially stretched dielectric film having a thickness in a range from about 5 microns to about 30 microns; and stretching the uni-axially stretched dielectric film along a transverse direction to form a bi-axially stretched dielectric film having a thickness less than 5 microns. The uni-axially stretched dielectric film is heated using infrared radiation during at least a duration of the step of stretching the uni-axially stretched dielectric film.

### DRAWINGS

These and other features, aspects, and advantages of the present invention will become better understood when the following detailed description is read with reference to the accompanying drawings, wherein:

FIG. 1 is a flow chart of a method, in accordance with some embodiments;

FIG. 2 is a flow chart of a method, in accordance with some embodiments;

FIG. 3 is a flow chart of a method, in accordance with some embodiments;

FIG. 4 schematically shows a top view of a system for stretching a dielectric material, in accordance with some embodiments;

FIG. 5 is a flow chart of a method, in accordance with some embodiments; and

FIG. 6 illustrates a film capacitor, in accordance with some embodiments.

### DETAILED DESCRIPTION

In the following specification and the claims, the singular forms “a”, “an” and “the” include plural referents unless the context clearly dictates otherwise. As used herein, the term “or” is not meant to be exclusive and refers to at least one of the referenced components being present and includes instances in which a combination of the referenced components may be present, unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “about” and “substantially”, is not limited to the precise value specified. In some instances, the approximating language may correspond to the precision of an instrument for measuring the value. Similarly, “free” may be used in combination with a term, and may include an insubstantial number, or trace amounts, while still being considered free of the modified term.

As used herein, the term “film” refers to a film formed using a melt-based method, in a continuous or discontinuous manner. In certain embodiments, the film is formed in a continuous manner. Further, the term “film” does not necessarily mean a uniform thickness of the material, and may have a uniform or variable thickness.

Stretched dielectric films, for example uni-axially stretched dielectric films and bi-axially stretched dielectric films, refer to oriented dielectric films prepared by stretching the dielectric material in at least one planar direction near a deformation temperature range of the substantially amorphous polymer. The deformation temperature range may refer to a temperature range in which molecular orientation of the polymer may be effected. Below the deformation temperature range, a film formed by the dielectric material may tend to break; and above the deformation temperature range, the film may elongate without orienting. The deformation temperature range for a given amorphous polymer can be readily determined by one skilled in the art. The deformation temperature range may be less than a melting or a decomposition temperature of the amorphous polymer.

As discussed previously, stretching techniques may be used for thinning of polymer films. Typically, melt-extruded films of amorphous polymers may be stretched along the longitudinal direction to form uni-axially stretched dielectric films having a thickness greater than 5 microns. However, further stretching of the uni-axially stretched dielectric film to reduce the thickness, for example below 5 microns, may result in one or more quality issues such as pin-holes, thickness non-uniformity, tin-canning instabilities, film breakage and wrinkles.

Embodiments of the specification address the noted shortcomings in the art. Some embodiments are directed to a method for forming a bi-axially stretched dielectric film. The method includes stretching a dielectric material along a transverse direction to form a bi-axially stretched dielectric film having a thickness less than 5 microns. The dielectric material is heated using infrared radiation during at least a duration of the stretching step. The dielectric material includes a substantially amorphous polymer having a glass transition temperature greater than 140 degree Celsius.

Therefore, embodiments of the specification advatangeously provide for methods of forming thin (less than 5 microns thick) bi-axially stretched dielectric films from dielectric materials including substantially amorphous polymers. As used herein, the term “substantially amorphous polymer” refers to a polymer that is substantially free of a crystalline phase. In some embodiments, the substantially amorphous polymer may have a small quantity of crystalline phase, for example less than 5 weight percent. In some embodiments, the amorphous polymer has a crystalline phase in a range from about 0.1 weight percent to about 2 weight percent. The amorphous polymer has a glass transition temperature greater than 140 degrees Celsius. In some embodiments, the amorphous polymer has a glass transition temperature in a range from about 150 degrees Celsius to about 250 degrees Celsius. These amorphous polymers having high glass transition temperature may be desirable to achieve the desired characteristics for a film capacitor such as high temperature stability and desired heat resistance. Suitable examples of amorphous polymers may include a polycarbonate, a polysulfone, a polyethersulfone, a polyamide-imide, a polyetherimide, or combinations thereof.

In certain embodiments, the dielectric material includes a polyetherimide. Non-limiting examples of suitable polyetherimides include ULTEM® 1000 resin series, ULTEM® 5000 resin series, and ULTEM® CRS 5000 resin series. In certain embodiments, the dielectric material consists essentially of a polyetherimide. The term “consists essentially of” as used herein means that the dielectric material primarily includes a polyetherimide and does not include additional materials, such as, metal or semiconductor particles that may alter the properties of the dielectric material. In some instances, the dielectric material may include a small quantity (less than about 100 ppm) of contaminants.

In some embodiments, the dielectric material may further include one or more fillers to improve the material properties, such as, dielectric constant and thermal conductivity. The fillers may include an organic material, an inorganic material or combinations thereof. The filler may have a primary dimension of the order of nanometers, for example from about 0.1 nanometer to about 1000 nanometers. Suitable examples of the fillers include, but are not limited to, alumina, silica, organic titanates, metal titanates such as barium titanate, or combinations thereof. The fillers may be present in a small amount (less than 30 volume percent, based on a total amount of the dielectric material), and uniformly dispersed into the amorphous polymer. The desired filler may be added to the amorphous polymer while the amorphous polymer is being synthesized or in a subsequent step by mixing.

The term “dielectric material”, as used herein, refers to a material obtained directly after a melt process, or alternately to a material that has undergone one or more processing steps (for example, stretching in a longitudinal direction) after the melt process.

In some embodiments, the method may further include a step of providing the dielectric material. The dielectric material may be procured or formed by melt-based methods. The dielectric material formed by melt-based methods may have good thermal stability and dielectric properties, and less shrinkage due to the absence of residual solvent as compared to that of the dielectric material processed or formed by solvent-based methods. In some embodiments, the dielectric material may be substantially free of a solvent. As used herein, the term “substantially free of a solvent” refers to a dielectric material that may contain no or less than 1 volume percent solvent.

In some embodiments, the dielectric material may be in the form of a melt, a web, or a film. Non-limiting examples of melt-based methods for forming the dielectric material may include melt-extrusion such as blown film extrusion or melt-casting.

In some embodiments, the dielectric material is in the form of a melt-extruded film. The term “melt-extruded film” as used herein refers to an as-formed film that has not undergone any substantial stretching in one or both of longitudinal and transverse directions. In some embodiments, the melt-extruded film has a thickness in a range of from about 100 microns to about 500 microns. In certain embodiments, the melt-extruded film has a thickness in a range of from about 250 microns to about 350 microns.

In some other embodiments, the dielectric material is in the form of a uni-axially stretched film. As used herein, the term “uni-axially stretched film” refers to a film that is formed by stretching a dielectric material along a single planar direction, that is, in a longitudinal direction of the film. The longitudinal direction of the film may refer to a direction extending along a length of the film. The longitudinal direction may also be referred to as a machine direction, and stretching the dielectric material along the longitudinal direction may be referred to as machine direction orientation (MDO) stretching. In some embodiments, the melt-extruded film may be stretched along the longitudinal direction (i.e., using MDO stretching) to form the uni-axially stretched film, before the step of stretching the dielectric material to form the bi-axially stretched film. In some other embodiments, the uni-axially stretched film may be procured as a pre-formed film from a suitable source. The uni-axially stretched film may have a thickness in a range from about 5 microns to about 30 microns. In some embodiments, the uni-axially stretched film may have a thickness in a range from about 8 microns to about 25 microns, and in certain embodiments, from about 10 microns to about 20 microns.

As noted, the dielectric material is stretched along the transverse direction to form a bi-axially stretched dielectric film having a thickness less than 5 microns. The term “bi-axially stretched dielectric film”, as used herein, refers to a dielectric film that is formed from a dielectric material that has been stretched along two planar directions (i.e., x-y directions), that is the longitudinal direction and a transverse direction. A transverse direction of the dielectric film refers to a direction perpendicular to the longitudinal direction of the dielectric film in the plane of the dielectric film. Stretching a dielectric material in the transverse direction may also be referred to as transverse direction orientation (TDO) stretching.

In embodiments wherein the dielectric material is in the form of the melt-extruded film, the method further includes stretching the melt-extruded film along the longitudinal direction. In such instances, the melt-extruded film may be stretched along the longitudinal direction either prior to the step of stretching along the transverse direction or simultaneously with the step of stretching along the transverse direction. In embodiments wherein the dielectric material is in the form of the uni-axially stretched dielectric film, the method includes stretching the uni-axially stretched dielectric film along the transverse direction to form the bi-axially stretched dielectric film

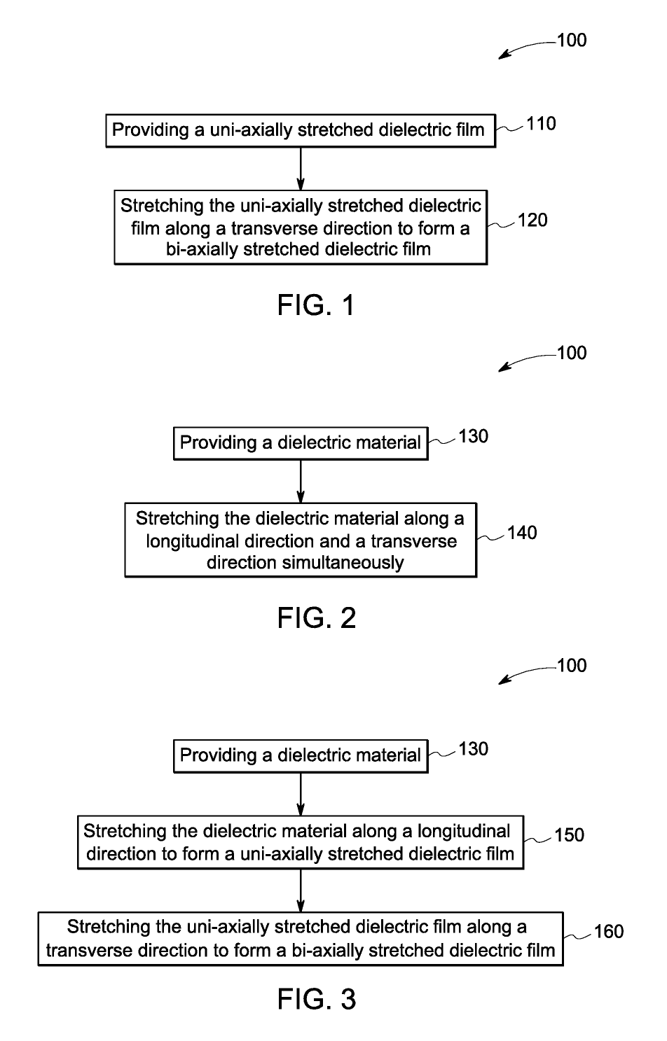

FIGS. 1-3 illustrate flow charts of a method 100 for forming the bi-axially stretched dielectric film of thickness less than 5 microns, according to some embodiments.

As shown in FIG. 1, in some embodiments, the method 100 includes the step 110 of providing a dielectric material in the form of a uni-axially stretched dielectric film. The uni-axially stretched dielectric film may be provided by procuring a pre-formed uni-axially stretched dielectric film or stretching the dielectric material along the longitudinal direction by using a suitable MDO stretching technique, for example differential speed rolls. The method further includes the step 120 of stretching the uni-axially stretched dielectric film along the transverse direction to form the bi-axially stretched dielectric film. The details of the stretching step are discussed hereinbelow.

As shown in FIGS. 2 and 3, in some embodiments, the method includes the step 130 of providing a dielectric material in the form of a melt, for example a melt-extruded film. The melt may be stretched along the longitudinal direction and the transverse direction simultaneously or sequentially, as illustrated in FIGS. 2 and 3. FIG. 2 illustrates the method 100 that includes the step 140 of simultaneously stretching the melt along the longitudinal direction and the transverse direction. In FIG. 3, the method 100 includes the step 150 of stretching the melt along the longitudinal direction to form the uni-axially stretched dielectric film before the step 160 of stretching the uni-axially stretched dielectric film along the transverse direction to form the bi-axially stretched dielectric film.

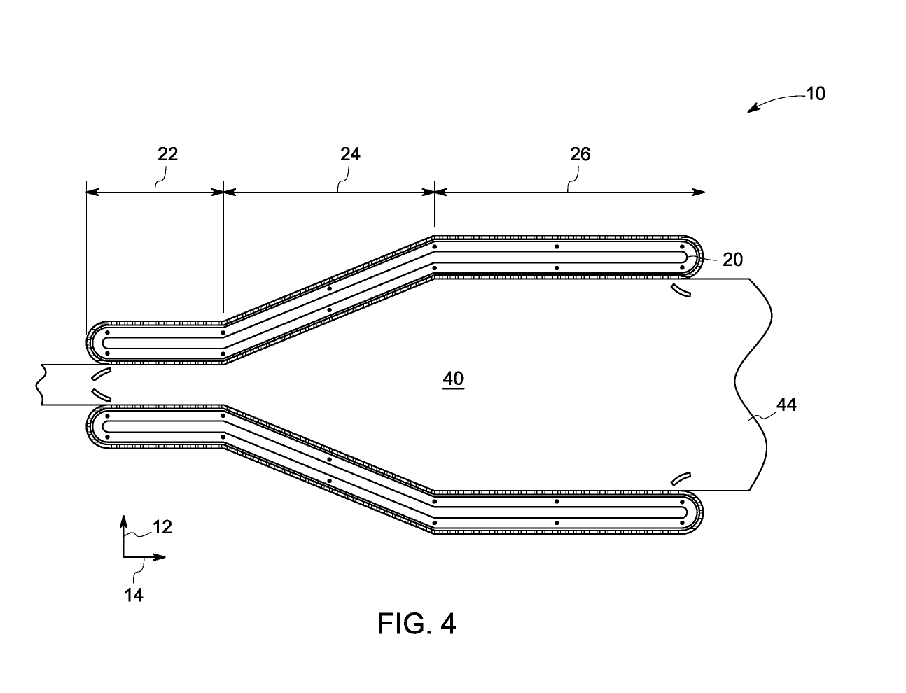

As mentioned earlier, the dielectric material is heated using infrared radiation during at least a duration of the stretching step. In some embodiments, the stretching step is carried out in a system configured to perform at least TDO stretching in the presence of infrared (IR) radiation during at least a duration of the stretching step. In some embodiments, the system may be further configured to perform MDO stretching. Such a system is described in detail below with reference to FIG. 4.

FIG. 4 shows a schematic top view of a system 10, for example an infra-red transverse direction orientation (IRTDO) system. The system 10 includes a tenter frame 20. The dielectric material to be stretched in the system 10 may be obtained from any appropriate source, such as a supply roll or directly from a melt-extrusion apparatus. As shown in FIG. 4, a dielectric material 40 may be supplied to the tenter frame 20 in the form of a continuous web (as produced from a typical film production line). The terms “web” and “dielectric material” may be used interchangeably in the specification. The tenter frame 20 may hold the dielectric material, for example with the help of tenter clips. The tenter frame 20 may be configured to stretch the dielectric material 40 at least along a transverse direction (shown by arrow 12). In some embodiments, the tenter frame 20 may also be configured to stretch the dielectric material 40 along a longitudinal direction (shown by arrow 14).

The system 10 may further include a plurality of infrared (IR) heaters. Infrared heaters (not shown) may be employed in various locations of the system 10 to heat the dielectric material 40 at least prior to the stretching step, during the stretching step, or after the stretching step. In some embodiments, the temperature of the dielectric material 40 is maintained within a predetermined temperature range suitable for the dielectric material used. Various portions of the dielectric material 40 (such as, a central portion or an edge portion) may be exposed to different temperatures to establish and maintain the desirable temperature differentials. In some embodiments, the dielectric material 40 is exposed to a temperature from about 500 degrees Fahrenheit to about 1000 degrees Fahrenheit in the various portions. The temperature of the dielectric material 40 may be in a range from about 450 degrees Fahrenheit to about 550 degrees Fahrenheit. Further, various cooling and pre-treating means may be employed in the system 10 for cooling and treating the dielectric material 40 either during or prior to the stretching step.

As illustrated in FIG. 4, in some embodiments, the tenter frame 20 may have at least three sections, for example a first section 22, a second section 24 and a third section 26. The dielectric material 40 is first supplied into the first section 22. In the first section 22, the dielectric material 40 is exposed to a predetermined temperature for a particular duration, prior to the stretching step. In some embodiments, the dielectric material 40 is exposed to a temperature in a range from about 800 degrees Fahrenheit to about 1000 degrees Fahrenheit. The duration for exposing the dielectric material 40 to a temperature in each of the three sections may depend on various processing parameters such as drawing rate, tenter speed, and the lengths of the respective sections.

With continued reference to FIG. 4, the heated dielectric material 40 is further supplied to the second section 24 where the dielectric material 40 is stretched at least along the transverse direction to form a bi-axially stretched dielectric film having a thickness of less than 5 microns. In embodiments where the dielectric material 40 is in the form of a uni-axially stretched dielectric film, the method includes stretching the uni-axially stretched dielectric film along the transverse direction. In these embodiments, the system 10 performs the TDO stretching in the second section 24.

In embodiments wherein the dielectric material 40 is in the form of “as-formed” melt (for example, a melt-extruded film), the method may include stretching the dielectric material 40 along the longitudinal direction and the transverse direction simultaneously. In these embodiments, the tenter frame 20 is further configured to perform the MDO stretching in the second section 24. In these instances, the dielectric material 40 may be stretched along the longitudinal direction and the transverse direction simultaneously using the tenter frame 20 for MDO stretching and TDO stretching. In embodiments wherein the method includes stretching the dielectric material along the longitudinal direction and the transverse direction sequentially, the tenter frame 20 is configured to perform the MDO stretching of the dielectric material 40 before performing the TDO stretching. In some embodiments, the MDO stretching of the dielectric material 40 may be performed before supplying the dielectric material to the second section 24 of the system 10 so that a uni-axially stretched dielectric film is supplied to the second section 24. In some embodiments, the MDO stretching may be performed outside the system 10 such that the uni-axially stretched dielectric film is supplied to the system 10 via the first section 22.

After the dielectric material 40 has been bi-axially stretched in the second section 24, the dielectric material may be moved into the third section 26 where the dielectric material is heat set within a temperature range appropriate for the amorphous polymer used. As an example, for a polyetherimide, the dielectric material may be exposed to a temperature in a range from about 600 degrees Fahrenheit to 900 degrees Fahrenheit in the third section 26 during the heat setting step. After the third section 26, a bi-axially stretched dielectric film 44 may be received from the system 10. In some embodiments, the thickness of the bi-axially stretched dielectric film 44 may be lower at a central portion when compared to the edge portions. The thicker edge portions may be slit from the bi-axially stretched dielectric film 44 prior to using the film or winding the film into a roll.

The thickness and uniformity of the bi-axially stretched dielectric film 44 may be controlled in part through various process parameters such as temperature, stretch ratio, drawing rate of the dielectric material during the stretching step. The dielectric material may be stretched at least 1.5 times to its original dimension in each direction (i.e., along the longitudinal direction and the transverse direction) to form the bi-axially stretched dielectric film 44. In some embodiments, the method includes stretching the dielectric material using a stretch ratio in a range from about 1.5 to about 6 at least along the transverse direction. In certain embodiments, the method includes stretching the dielectric material using a stretch ratio in a range from about 2 to about 5 at least along the transverse direction. The stretch ratio along the transverse direction may be calculated by dividing the width of the bi-axially stretched dielectric material 44 exiting the system 10 by the width of the dielectric material 40 entering to the system 10. For instance, if the width of the bi-axially stretched dielectric material 44 at the exit of system 10 is 20 inches and the width of the dielectric material 40 at an entrance of system 10 is 10 inches, then the stretch ratio is equal to 2.

In the second section 24, during the stretching step, the dielectric material may be exposed to a temperature in a range from about 600 degrees Fahrenheit to about 900 degrees Fahrenheit for a particular duration of the stretching step. The dielectric material 40 may be exposed to the temperature continuously or periodically during the stretching step. Further, the dielectric material may be exposed to different temperatures at different portions (such as the central portion and the edge portions) such that a temperature of the dielectric material may desirably vary from the central portion to the edge portions. In some embodiments, the edge portions may be exposed to a lower temperature (e.g., from about 600 degrees Fahrenheit to about 700 degrees Fahrenheit) than that of the central portion. As discussed, the dielectric material may be heated using IR radiation. The temperature of the dielectric material may be desirably maintained or varied using IR heaters at various desirable locations inside the system 10.

The edge and central portions of the dielectric material may be heated to the appropriate temperatures so that the dielectric material can be sufficiently stretched without tearing the dielectric material (that is, the web) from the tenter clips. If the temperature at the edge portions is low, the dielectric material may not stretch at the edge portions and the thickness may be larger at the edges portions compared to the central portion of the dielectric material. If the temperature at the edge portions is high, the dielectric material may be soft at the edge portions, and the dielectric material may either tear or break or detach from the tenter clips. In some embodiments, the temperature of the IR heaters is varied in the direction across the longitudinal direction of the dielectric material. In some instances, the edge portions gripped in the tenter clips may be protected from IR heat using ceramic heat deflectors. In this way, premature softening of the dielectric material in these edge portions may be prevented.

The term, “drawing speed”, as used herein, refers to a speed by which the dielectric material is moved in the longitudinal direction or drawn out of the system. In the system 10, the drawing speed of the dielectric material may be controlled by a tenter speed. In some embodiments, the method includes stretching the dielectric material using a drawing speed in a range from about 1 foot/minute to about 50 feet/minute (ft/min). In certain embodiments, the drawing speed is in a range from about 10 ft/min to about 30 ft/min.

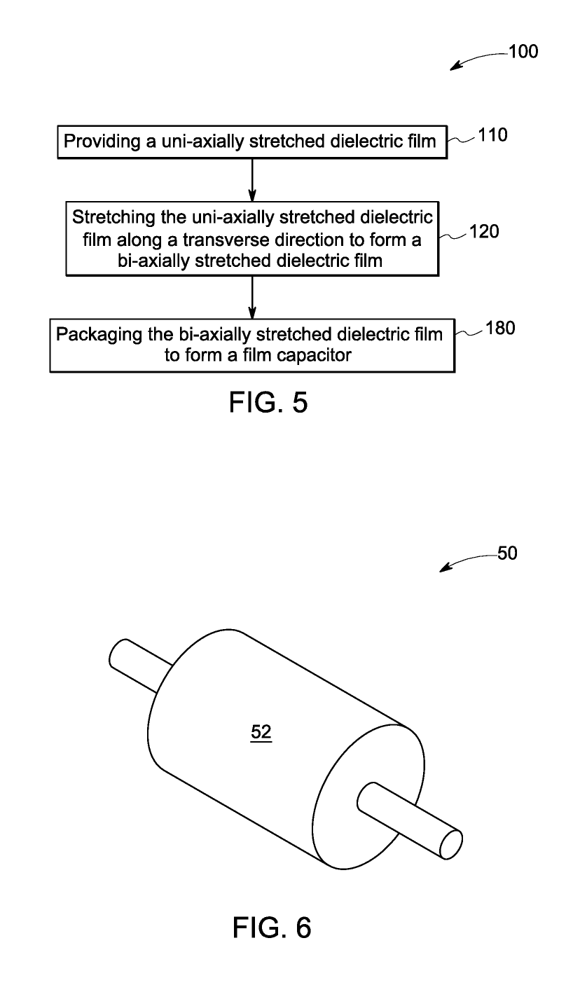

In some embodiments, as shown in FIG. 5, the method 10 further includes the step 180 of packaging the bi-axially stretched dielectric film 44 to form a film capacitor 50 (FIG. 6). Packaging step 180 may include metallizing the bi-axially stretched dielectric film 44 to form a metallized dielectric film and winding the metallized dielectric film in a suitable configuration. The bi-axially stretched dielectric film may be metallized at one side or both sides of the film.

Some embodiments provide a bi-axially stretched dielectric film formed by the method as discussed hereinabove. The bi-axially stretched dielectric film has a thickness less than 5 microns. In some embodiments, the bi-axially stretched dielectric film has a thickness in a range from about 0.1 micron to about 4 microns. In certain embodiments, the thickness of the bi-axially stretched dielectric film is in a range from about 0.5 micron to about 3 microns. Moreover, the bi-axially stretched dielectric film may have substantially uniform thickness. As used herein, the term “substantially uniform thickness” means that the thickness variation across the bi-axially stretched dielectric film is less than 10 percent. In one embodiment, the bi-axially stretched dielectric film has a dielectric breakdown strength of at least about 400 volts/micron. In certain embodiments, the bi-axially stretched dielectric film has a dielectric breakdown strength in a range from about 400 volts/micron to about 1000 volts/micron.

Some embodiments present a film capacitor that includes a bi-axially stretched dielectric film formed by the method as discussed hereinabove. The film capacitor may be used, for example in inverters for hybrid electric vehicles, engine starters for avionics, pulsed-power applications, and oil-and-gas electronic devices. FIG. 6 shows a schematic of a film capacitor 50. The film capacitor 50 includes a metallized dielectric film 52 wound in a cylindrical configuration of the capacitor. The bi-axially stretched dielectric film may be metallized on one side (that is, on one surface) or on both the sides to form the metallized dielectric layer. A metallization layer may include a metal such as aluminum, copper, or zinc, which is vacuum deposited on the bi-axially stretched dielectric film. The metal layer is usually thin, and may have a thickness of about 200-500 angstroms.

Embodiments of the present disclosure provide methods for producing dielectric films of thickness less than 5 microns from an amorphous polymer. According to some embodiments, these thin dielectric films have the desired thickness uniformity, desired dielectric properties, a high breakdown strength (at least 450 V/micron), and are able to continuously operate at elevated temperatures of 120 degrees Celsius and higher. Furthermore, these films may have low level of impurities and no surface imperfections because these films are produced entirely from a melt (no use of a solvent). The combination of small film thickness (less than 5 microns) with high dielectric constant and high dielectric strength may be beneficial in the manufacturing of high energy density film capacitors that can work at elevated temperatures as compared to state of the art polypropylene capacitors.

### EXAMPLES

### Comparative Example

A polyetherimide (PEI) film (Ultem™) of thickness 13 microns was processed by sequential stretching in MDO and TDO in an oven using convection air for heating. The PEI film had periodic surface instabilities of the tin-canning type. An average dielectric breakdown strength of the PEI film was 450 V/micron (one standard deviation of 20 measurements equal to 23 V/micron). During the process, the MDO stretching was run at oven temperatures between 400 degrees Fahrenheit and 465 degrees Fahrenheit (° F.), at a drawing speed between 10 ft/min and 15 ft/min, and a cooling temperature at the end of the process equal to 150° F. After completing the MDO stretching, the TDO stretching of the PEI film was run at oven temperatures between 435° F. and 455° F., at a drawing speed of 15 ft/min, and a stretch ratio of between 1.1 and 1.45. A bi-axially stretched PEI film of thickness about 8 microns was attained while maintaining the desired performance characteristics (e.g., no wrinkles and desired dielectric properties). An average dielectric breakdown strength of the bi-axially stretched PEI film of about 8 microns was 451 V/micron (one standard deviation of 20 measurements equal to 40 V/micron). It was observed that the processing conditions (that is, convection air heating) were not able to provide a required environment to produce a film of thickness less than 5 microns. It was concluded that the convection air used for heating inside the oven did not allow the PEI film to remain attached to the clips of a conveying mechanism used to move the film inside the oven. Furthermore, the oven heaters had insufficient heating capability to heat up the PEI film above the polymer's glass transition temperature.

### Example 1

A uni-axially stretched polyetherimide (PEI) film of nominal thickness 6 microns (Ultem™) was provided. The PEI film was about 19 inches wide and had surface imperfections (e.g., surface instabilities of the tin-canning type). These surface instabilities might have prevented this roll of PEI film from being metallized to finally use the metallized PEI film to form film capacitors.

To carry out TDO stretching of the PEI film, a web roll of the PEI film was transported to an entrance of an infra-red transverse direction orientation (IRTDO) system by rollers. At the entrance, the edges of the PEI film were gripped by the tenter clips of a tenter frame. The PEI film entering the tenter clips was at about room temperature. After gripping the PEI film, the tenter clips were moved in relatively straight parallel rails of tenter frame into a first section 22 (referring to FIG. 4) where the temperature of the PEI film was increased to a deformation temperature of PEI, with the help of oven's IR heaters being kept at temperatures between 850° F. and 900° F. The IR heaters were arranged beyond the rails of the tenter clips to provide uniform heat flux across the width of the PEI film. After the first section 22, the rails of the tenter frame diverged and opposed pairs of clips were accelerated to separate from adjacent pairs to thereby stretch the heated PEI film in the transverse direction in the second section 24 of the IRTDO system. IR heaters were used inside the IRTDO system to maintain the desired temperature of the PEI film at various locations. The separation of the rails of the tenter frame changed from about 17 inches at the entrance of the second section 24 to about 25.5 inches at the exit of the system. Therefore, the PEI film was stretched about 1.5 times its original width, and transformed into a bi-axially stretched PEI film that was about 3 microns to about 4 microns thick at the exit of the IRTDO system. During the TDO stretching process, a tenter speed was about 5 ft/min. The temperature of the IR heaters in the second section 24 was kept higher than 750° F.

After the second section 24, in which the rails of tenter frame diverged, these rails became parallel again in the third and final section 26. In the third section 26, the bi-axially stretched PEI film was heat set by exposing the film to temperatures between 600° F. and 700° F. using IR heaters. The resulting bi-axially stretched PEI film was between 2.5 and 3.5 microns thick when measurements were taken at the central portion of the web. The temperature of the bi-axially stretched PEI film at the exit of the IRTDO system was measured equal to about 530° F. This temperature was higher than that of the bi-axially stretched PEI film of the Comparative Example 1.

Twelve measurements taken one inch apart at the central portion of the bi-axially stretched film showed an average film thickness equal to 3.06 microns with a standard deviation equal to 0.22 micron. Similar measurements taken one meter away from the previous location showed an average film thickness equal to 3.00 microns with one standard deviation equal to 0.43 micron. These consistent results suggested that the process was able to produce bi-axially stretched films containing no wrinkles with a relatively uniform thickness at the central portion of the film.

Twenty measurements of the original wrinkled 6 micron thick PEI film showed an average film thickness of 6.23 microns with one standard deviation equal to 0.03 micron, and an average dielectric breakdown strength equal to 520 V/micron with a standard deviation equal to 37 V/micron. Twenty measurements of the resulting bi-axially stretched PEI film (no wrinkles) produced by the above process showed an average film thickness of 3.16 microns with a standard deviation equal to 0.26 micron, and an average dielectric breakdown strength equal to 479 V/micron with a standard deviation equal to 45 V/micron. The lower average breakdown strength of the thinner bi-axially stretched PEI film compared to the original wrinkled 6 micron thick PEI film was due to one breakdown strength value measured 333 V/micron at one spot, most of other values of breakdown strength were as high as 535 and 563 V/micron at other portions of the measured area of the film. These values of thickness and breakdown strength were measured on a circular sample of approximate 2 inches in diameter taken from the central portion of the web. The thickness measurements were made using Filmetrics technique, and the breakdown strength measurements were made using ASTM ball-plan sample fixture along with a Slaughter AC/DC Hipot tester w/power supply. This resulting 3.2 microns bi-axially stretched PEI film of the web length 550 feet was produced with no film breakage or processing problems, and collected on a winder of the machine. It was observed that the resulting 3.2 microns bi-axially stretched PEI film produced was free of surface imperfections and had comparable breakdown strength compared to the original wrinkled 6 micron thick PEI film.

### Examples 2-7

Six polyetherimide (PEI) films (Ultem™) were provided. The PEI films had surface imperfections (e.g., surface instabilities of tin-canning type). Details of the wrinkled PEI films and the method used to process them, for example web-roll lengths, widths, thicknesses, unwind tension are provided in Table 1. The PEI films were processed using the same method as described above in Example 1 to form bi-axially stretched PEI films. Similar measurement processes were performed for measuring average thicknesses and breakdown strengths of bi-axially stretched PEI films as discussed in Example 1.

Table 1 shows the processing conditions and parameters (e.g., IR heaters' temperatures, tenter speeds, rail separations, stretch ratios, web rewind tensions, web exit widths, web exit thicknesses) used while processing the PEI films in Examples 2-7. Table 1 further shows average thicknesses and average breakdown strengths measured at two different regions (region 1 and region 2) of resulting bi-axially stretched PEI films of Examples 2-7. The resulting bi-axially stretched PEI films of examples 2-4 had average thicknesses between about 2 microns and 4 microns and average breakdown strengths higher than 400 V/micron. The conditions used in Example 5 produced a bi-axially stretched PEI film having an average thickness of about 4 microns and a breakdown strength higher than 440 V/micron. A bi-axially stretched PEI film produced in Example 7 showed an average thickness below 2 microns with a relatively small standard deviation in region 1.

TABLE 1

| | | Example | | | | | |
|---|---|---|---|---|---|---|---|
| parameters | | Example 2 | Example 3 | Example 4 | Example 5 | Example 6 | Example 7 |
| Web-roll width | | 19 | 19 | 19 | 19 | 19 | 19 |
| (inches) | | | | | | | |
| Web-roll length | | 300 | 280 | 1380 | 4340 | 50 | 120 |
| (feet) | | | | | | | |
| Web thickness | | 6 | 6 | 6 | 7 | 7 | 7 |
| Roll unwind | | 30 | 30 | 30 | 30 | 20 | 20 |
| tension (%) | | | | | | | |
| Rail separation # | | 16.5 | 16.5 | 16.5 | 16.5 | 16.5 | 15 |
| 1 (inches) | | | | | | | |
| Rail separation # | | 25.5 | 25.5 | 25.5 | 25.5 | 35 | 35 |
| 2 (inches) | | | | | | | |
| Stretch ratio | | 1.55 | 1.55 | 1.55 | 1.55 | 2.12 | 2.33 |
| Tenter speed | | 4.9 | 10 | 10 | 20 | 10 | 10 |
| (drawing speed) | | | | | | | |
| (feet/minute) | | | | | | | |
| Web Rewind | | 24 | 25 | 24 | 37 | 30 | 30 |
| tension (%) | | | | | | | |
| IR heaters set | | 850-900 | 850-900 | 850-900 | 900 | 875-900 | 875-900 |
| temperature (° F.) | | | | | | | |
| in the first section | | | | | | | |
| IR heaters set | | 600 | 600 | 600 | 600 | 600 | 600 |
| Temperature (° F.) | | | | | | | |
| in the third | | | | | | | |
| Web exit width | | 26 | 26 | 26 | 26 | 38 | 38 |
| (inches) | | | | | | | |
| Web exit trimmed | | 11.5 | 11.5 | 19.87 | 19.87 | 25.25 | 23.25 |
| width (inches) | | | | | | | |
| Web exit | | 3-4 | 3-4 | 3-4 | 4-5 | 2-3 | 2-3 |
| thickness | | | | | | | |
| (microns) | | | | | | | |
| Web thickness (microns) | Region 1 | | 3.95/0.22 | 3.93/0.31 | 4.41/0.21 | | 1.77/0.16 |
| (Average/standard deviation) | Region 2 | | 2.15/0.17 | 2.39/0.23 | 3.29/0.31 | | 3.09/0.08 |
| Dielectric Breakdown Strength | Region 1 | | 436/89 | 465/68 | 464/73 | | 357/182 |
| (V/micron) (Average/standard | Region 2 | | 441/105 | 422/90 | 448/101 | | 457/97 |
| deviation) | | | | | | | |

While only certain features of the invention have been illustrated and described herein, many modifications and changes will occur to those skilled in the art. It is, therefore, to be understood that the appended claims are intended to cover all such modifications and changes as fall within the true spirit of the invention.

1. A method, comprising:
stretching a dielectric material along a transverse direction to form a bi-axially stretched dielectric film having a thickness less than 5 microns, wherein the dielectric material is heated using infrared radiation during at least a duration of the stretching step, and wherein the dielectric material comprises a substantially amorphous polymer having a glass transition temperature greater than 140 degrees Celsius.

2. The method of claim 1, wherein the dielectric material is in the form of a melt-extruded film.

3. The method of claim 2, further comprising stretching the dielectric material along a longitudinal direction before the step of stretching the dielectric material along the transverse direction.

4. The method of claim 2, wherein the stretching step further comprises stretching the dielectric material along a longitudinal direction while stretching the dielectric material along the transverse direction.

5. The method of claim 1, wherein the dielectric material is in the form of an uni-axially stretched dielectric film.

6. The method of claim 5, wherein the uni-axially stretched dielectric film has a thickness in a range from about 5 microns to about 30 microns.

7. The method of claim 1, wherein the stretching step is performed while exposing the dielectric material to a temperature in a range from about 500 degrees Fahrenheit to about 1000 degrees Fahrenheit.

8. The method of claim 1, wherein the stretching step comprises stretching the dielectric material using a drawing speed in a range from about 1 foot/minute to about 50 feet/minute.

9. The method of claim 1, wherein the stretching step comprises stretching the dielectric material using a stretch ratio in a range from about 1.5 to about 6.

10. The method of claim 1, wherein the dielectric material is substantially free of a solvent.

11. The method of claim 1, wherein the substantially amorphous polymer comprises a polyetherimide.

12. The method of claim 1, wherein the substantially amorphous polymer comprises a polycarbonate, a polysulfone, a polyethersulfone, a polyamide-imide, or combinations thereof.

13. The method of claim 1, further comprising packaging the bi-axially stretched dielectric film to form a film capacitor.

14. A bi-axially stretched dielectric film formed by the method in accordance with claim 1.

15. The bi-axially stretched dielectric film of claim 14, wherein the bi-axially stretched dielectric film has a thickness in a range from about 0.1 micron to about 5 microns.

16. The bi-axially stretched dielectric film of claim 14, wherein the bi-axially stretched dielectric film has a substantially uniform thickness.

17. The bi-axially stretched dielectric film of claim 14, wherein the bi-axially stretched dielectric film has a dielectric breakdown strength greater than 400 volts/micron.

18. A film capacitor comprising a bi-axially stretched dielectric film formed by the method in accordance with claim 1.

19. A method, comprising:
providing a melt-extruded film comprising a polyetherimide;
stretching the melt-extruded film along a longitudinal direction to form an uni-axially stretched dielectric film having a thickness in a range from about 5 microns to about 30 microns; and
stretching the uni-axially stretched dielectric film along a transverse direction to form a biaxially stretched dielectric film having a thickness less than 5 microns, wherein the uni-axially stretched dielectric film is heated using infrared radiation during at least a duration of the step of stretching the uni-axially stretched dielectric film.
